(19) United States
(12) Patent Application Publication
(10) Pub. No.: US 2012/0011216 A1
(43) Pub. Date: Jan. 12, 2012

(54) Method for associating a code with an electronic document, a hard document and storage information relating to the hard document

(76) Inventor: Thomas Zuber, Los Angeles, CA (US)

(21) Appl. No.: 13/247,813

(22) Filed: Sep. 28, 2011

Related U.S. Application Data
(63) Continuation-in-part of application No. 12/575,442, filed on Oct. 7, 2009.
Application No. 12/575,442 is a continuation-in-part of application No. 12/493,096, filed on Jun. 26, 2009.
(60) Provisional application No. 61/465,407, filed on Mar. 18, 2011.
(60) Provisional application No. 61/481,668, filed on May 2, 2011.

(51) Int. Cl. G06F 15/16; G06F 17/00

(52) U.S. Cl. 709/206; 709/204; 235/375

(57) ABSTRACT

A system and method for automatically associating hard copy and electronic versions of a document with a code. The electronic version of a document is displayed using an image viewing tool which also displays a code associated with the document. Hardcopies of the electronic document may be printed and will include the same code present in the electronic version of the document. The code linking electronic and hard copy versions of the document provides information relating to each version of the document, such as physical storage location of the hard copy, electronic location of the document, and the identity of members who have recently accessed the document.

### CROSS REFERENCE TO RELATED APPLICATIONS

This application is a continuation-in-part of U.S. patent application Ser. No. 12/493,096, filed on Jun. 26, 2009, the contents of which are hereby incorporated in the entirety. This application is also related to U.S. patent application Ser. No. 12/575,442, filed on Oct. 7, 2009, U.S. patent application Ser. No. 12/885,235, filed on Sep. 17, 2010, U.S. patent application Ser. No. 13/011,655, filed on Jan. 21, 2011, U.S. patent application Ser. No. 13/023,461, filed on Feb. 8, 2011, U.S. Patent Application No. 61/465,407, filed on March 18, 2011, U.S. Patent Application No. 61/481.668 filed on May 2, 2011, and U.S. patent application Ser. No. 13/109,556 filed on May 17, 2011. The contents of each of these patent applications are hereby incorporated in their entirety.

### BACKGROUND OF THE INVENTION

The present invention relates to systems and methods for interactive collaboration within a plurality of secure, online social networking communities made up of virtual identities enabled with multiple social networking functionalities, document management functionalities, and integrative functionalities.

Social networking web sites, such as Facebook.com and MySpace.com, are communities of persons having virtual identities enabled with social networking functionalities. Such sites are often geared towards users having special recreational or social interests such as baseball games, motorcycle riding or dating. There are also social networking web sites for professionals—for example, LinkedIn.com, EsqChat.com and LegallyMinded.com—and some of these sites are communities of persons having virtual identities enabled with social networking functionalities. However, such social networking web sites do not include integration with a secured document management system, which integration provides synergies that facilitate viral online growth, as well as the foundation for the conception and creation of integration functionalities that facilitate business networking, operations and transactions.

The prior art also discloses document management systems, meaning systems for managing, creating, editing, deleting, saving, organizing and accessing documents. For instance, Microsoft Office®, more particularly, its Word®, Excel®, and Power Point® applications, allow for creating, editing, deleting, saving and accessing of documents. Microsoft Office® also includes an Outlook® application that allows creating, editing, deleting, saving, accessing, sending and receiving emails. Another prior art system, Interwoven, Inc., offers a document management system that allows for organizing, storing and retrieving documents.

The preceding document management systems are generally examples of stand-alone document systems, most of which are only available as stand-alone systems that require a dedicated network and are not available online. Thus many systems offering document management systems are not available with the type of economies of scale obtainable when offered to a larger community online. Some systems provide some functionalities of a document management system in an online context. For instance, Google.com and OpenOffice.org offer applications for creating, editing, deleting, saving and accessing documents in an online context, and for creating, editing, deleting, saving, accessing, sending and receiving emails in an online context. For instance, HyperOffice.com offers an online document organization system for organizing, storing and retrieving documents online. However, such document management systems that operate in an online context are not offered in the context of integration with a networking community made up of virtual identities enabling social networking functionalities, enhanced with the integrative functionalities described below. Thus, the prior art lacks a means to allow a user to enable a single online virtual identity, via entry of a single username and password, that allows the user to manage documents in multiple secure online document management databases, where each document management database is shared by a different organization (or other group of users), and where each organization desires to keep documents confidential to the organization secure from and inaccessible by the other organizations as a wholes. Thus, the prior art also lacks a means of allowing the user the ability to easily move a document from one such secure online document management database to another.

One drawback of existing document management system comes in their inability to effectively manage and coordinate hard copy documents and electronic counterparts of those hard copy documents. For example, a document that originates in paper form is typically filed in a filing cabinet and is also scanned electronically and stored in an electronic document management system. Accordingly, one document exists in both electronic and hard copy form, but are stored in separate ways. Thus, the prior art lacks a means whereby a user can effectively coordinate the movement or storage of those two iterations of the document.

Thus there remains a need for a document management system integrated into a truly cooperative community of virtual identities that enable a plurality of social networking functionalities. There furthermore remains a need for a document management system that permits the user to coordinate the movement and storage of multiple iterations of a document, such as electronic and hard copy versions of the same document. Finally, there remains a need for the integrative functionalities the creation of which is conceivable and made possible in the context of such integration, which integrative functionalities will facilitate business networking, operations and transactions, and allow cloud computing portals for document management systems to more fully tap the viral power of the internet as enabled by social networking functionalities.

### BRIEF SUMMARY OF THE INVENTION

The future of web-based computing is rapidly taking shape. Emerging trends include such concepts as cloud computing and Web 2.0, in which a web or cloud-based infrastructure designed for rapid delivery of computing resources is made available through either a public or private provider. While many definitions of these concepts exist, the next generation of computing architecture will focus on delivering business and consumer services with a user focus, designed to encourage rapid innovation and efficient, collaborative decision making. Many market participants are actively trying to develop a dominant online portal for cloud computing, although none has yet done so.

The present invention describes an integration of cloud computing-based services through a portal that combines social networking functionalities with document management system functionalities, further enhanced with integrative functionalities as described herein.

The present invention discloses a secure, network-based collaborative work environment in which one or more members of an online community having virtual identities enabled with social networking functionalities and document management functionalities are able to access and utilize a variety of integrative functionalities as fully described herein. The integrative functionalities include, but are not limited to:

clicking on an icon on a virtual identity existing in the context of a social networking website and thereby giving the person associated with such virtual identity access to (or retracting access of the person associated with such virtual identity to) a document management room shared by a network that at least some persons associated with virtual identities do not have access to;

clicking and dragging a document stored in a first folder containing documents shared by members of a first network of members (and not shared with members not of said first network) to a second folder containing documents shared by members of a second network (and not shared with members not of said second network), such that the document is shared with members of the first network and members of the second network, wherein at least one of said members of said second network is not also a member of said first network;

automatically creating a bar code or other code, whereby that code is assigned to a document stored in the document management system, and whereby that code is assigned to hard copies of that electronic document, and whereby identifying information about the electronic and hard copy documents is associated with those documents within the document management system by means of that code; and

other features and advantages of the present invention will become more apparent from the following description of the embodiments, taken together with the accompanying several views of the drawings, which illustrate, by way of example, the principles of the invention.

### BRIEF DESCRIPTION OF THE SEVERAL VIEWS OF THE DRAWING

FIG. 1 is a conceptual diagram of a system and method of providing an online social community with integrative functionalities according to one embodiment of the present invention;

FIG. 2 is an exemplary graphical implementation of one aspect of the present invention showing a member's virtual identity and having several integrative functionalities accessible;

FIG. 3 is an exemplary graphical implementation of another aspect of the present invention showing multiple views of a document management system;

FIG. 4 is an exemplary implementation of another aspect of the present invention showing information on a member's virtual identity and implementation of integrative functionalities therein;

FIG. 5 is an exemplary graphical implementation of another aspect of the present invention showing a home page;

FIG. 6 is an exemplary graphical implementation of another aspect of the present invention showing a member profile;

FIG. 7 is an exemplary graphical implementation of another aspect of the present invention showing a member profile as viewed by members who are not contacts;

FIG. 8 is an exemplary graphical implementation of another aspect of the present invention showing a member profile of a second members as viewed by an owner;

FIG. 9 is an exemplary graphical implementation of another aspect of the present invention showing a member profile as viewed by members who are contacts;

FIG. 10 is an exemplary graphical implementation of another aspect of the present invention showing lists of contacts;

FIG. 11 is an exemplary graphical implementation of another aspect of the present invention showing lists of links to network profiles;

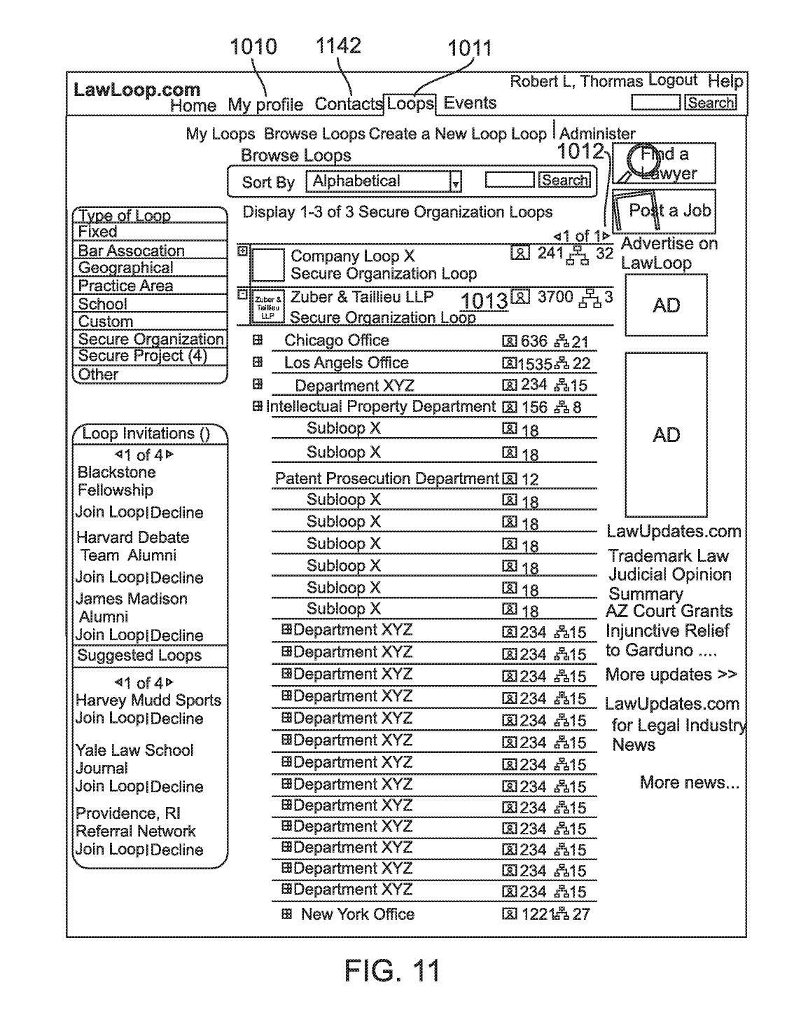

FIG. 12 is an exemplary graphical implementation of another aspect of the present invention showing a network profile;

FIG. 13 is an exemplary graphical implementation of another aspect of the present invention showing a document management tool with a document filing tool and email tool active;

FIG. 14 is an exemplary graphical implementation of another aspect of the present invention showing a document management tool with a document filing tool and word processor tool active;

FIG. 15 is an exemplary graphical implementation of another aspect of the present invention showing a document management tool with a document filing tool and spreadsheet tool active;

FIG. 16 is an exemplary graphical implementation of another aspect of the present invention showing a document management tool with a document filing tool and presentation tool active;

FIG. 17 is an exemplary graphical implementation of another aspect of the present invention showing a document management tool with a document filing tool and image viewing tool active;

FIG. 18 is an exemplary graphical implementation of another aspect of the present invention showing a document management tool with a document filing tool and word processor tool active in a multi-column format;

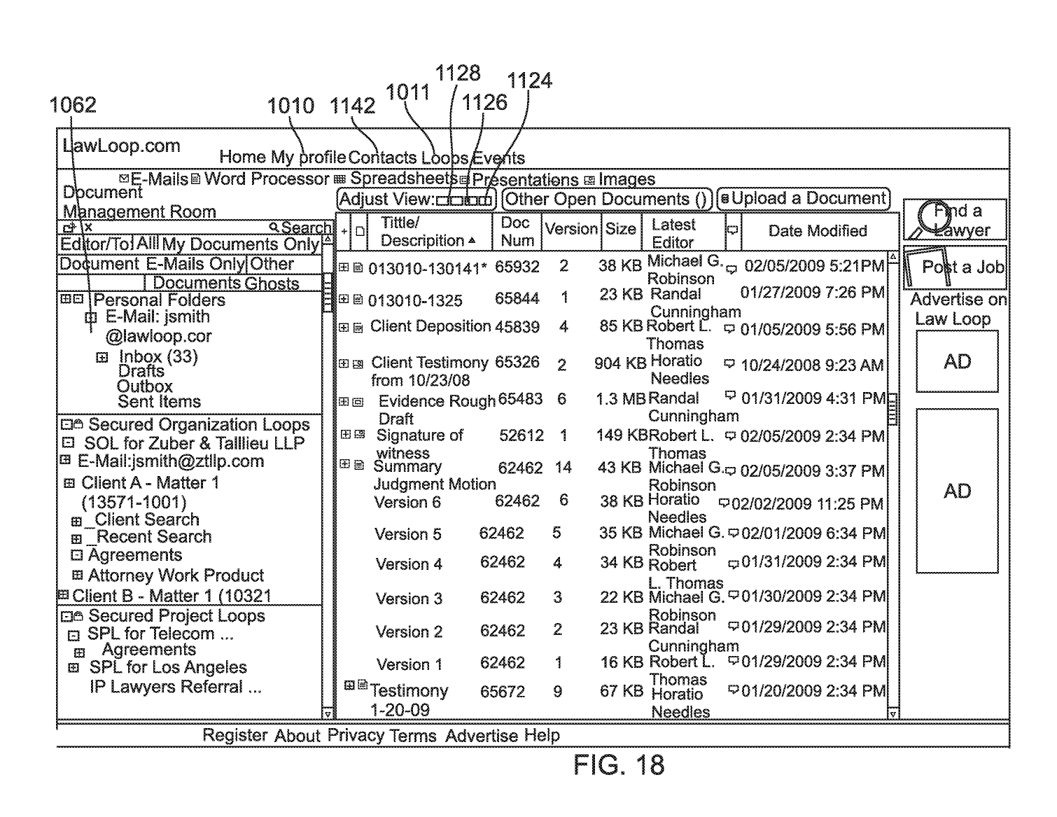

FIG. 19 is an exemplary graphical implementation of another aspect of the present invention showing lists of shared contacts; and

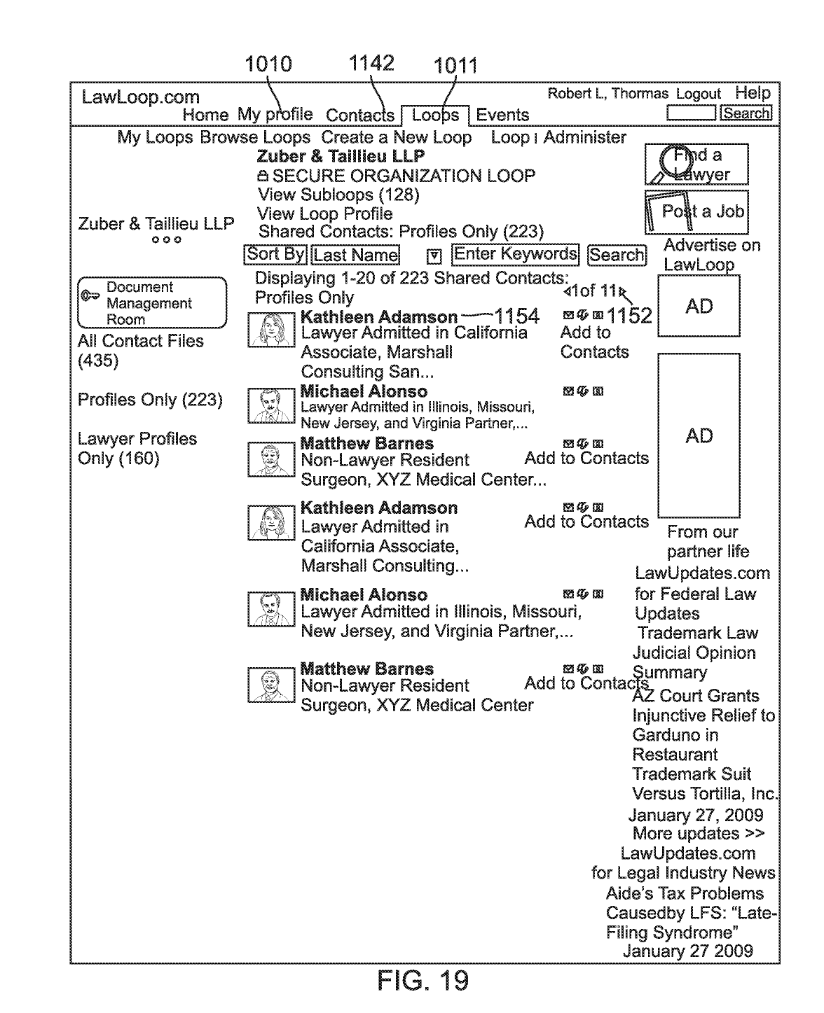

### DETAILED DESCRIPTION OF THE INVENTION

In the following description of the present invention reference is made to the accompanying drawings which form a part thereof, and in which is shown, by way of illustration, exemplary embodiments illustrating the principles of the present invention and how it may be practiced. It is to be understood that other embodiments may be utilized to practice the present invention and structural and functional changes may be made thereto without departing from the scope of the present invention. Without limiting the generality of the foregoing, some of the descriptions and examples below relate to law firms, and to attorneys, staff persons and clients of law firms, as a matter of convenience, and for the sake of illustration, only; and the present invention may be utilized and practice by other organizations, professionals, entities and/or persons, and such use and practice is contemplated by and included within the scope of the present invention.

The present invention discloses an online social networking community. More particularly, the present invention discloses a system and method for providing the secure, network-based collaborative work environment within the context of the online community. The present invention further discloses a system and method for associating a code with electronic and hard copy versions of documents such that identifying information about each version of the documents is associated with each copy of the document. The present invention further discloses integrative functionalities which lie on top of, and are made possible by, combining social networking functionalities and document management functionalities, within a remote, secure online environment.

### Social Networking Functionalities

Members of the online community have an account with the online community which defines a member virtual identity associated with the member. The member virtual identity typically includes web pages that convey information about the member to one or more other members of the community, is enabled with one or more social networking functionalities, and is an online representation of that member that may take many different forms. In regard to each member, participation in the online community typically requires identification verification in order to enable the member's member virtual identity, and therefore means of identifying a member, such as a username, a password, fingerprints, or some other form of identification means relating an identity of a member to his or her member virtual identity, may also be included within the member virtual identity so that a member entering such information can be verified as the owner of the member virtual identity. The member virtual identity allows members to participate in at least one social functionality available within the online community. Alternatively, the member virtual identity may be represented by an icon (“icon” meaning a graphical link, textual link, or other link to a web page or a location on a web page) instead of web pages. Typically, though, a member virtual identity will consist simply of a login account of the relevant member, a web page or a collection of web pages associated with the member (which typically include/s a profile (defined below) of the member and may or may not include additional web pages), and at least one social networking functionality (defined below).

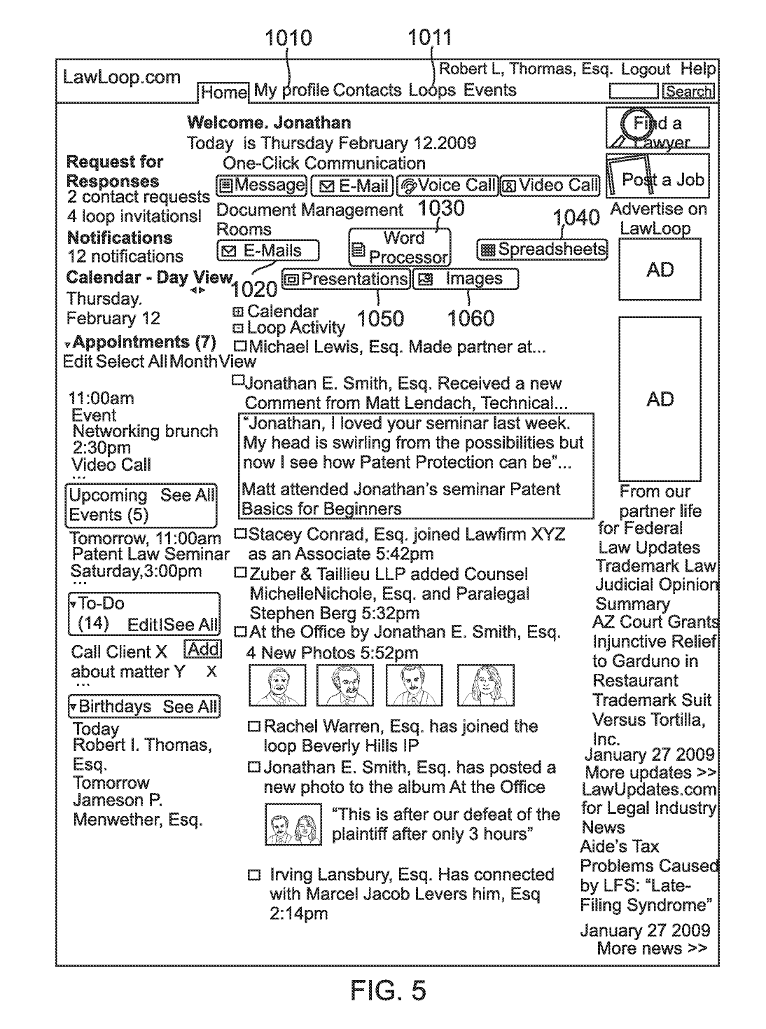

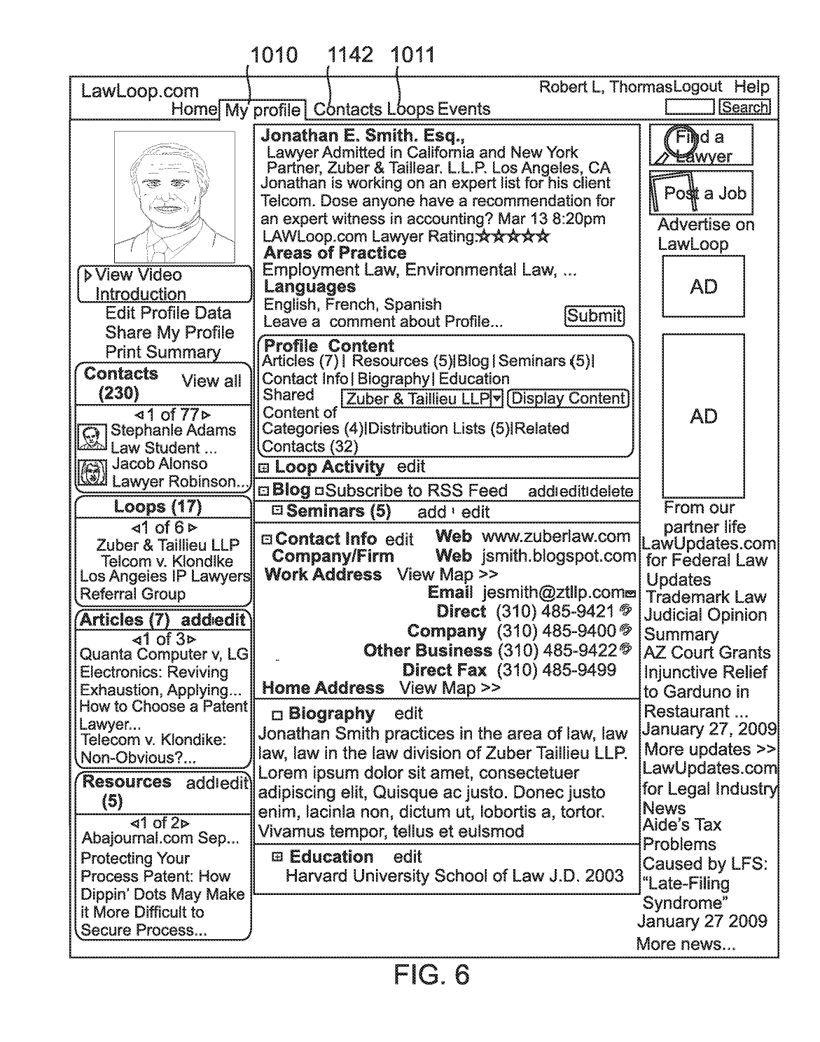

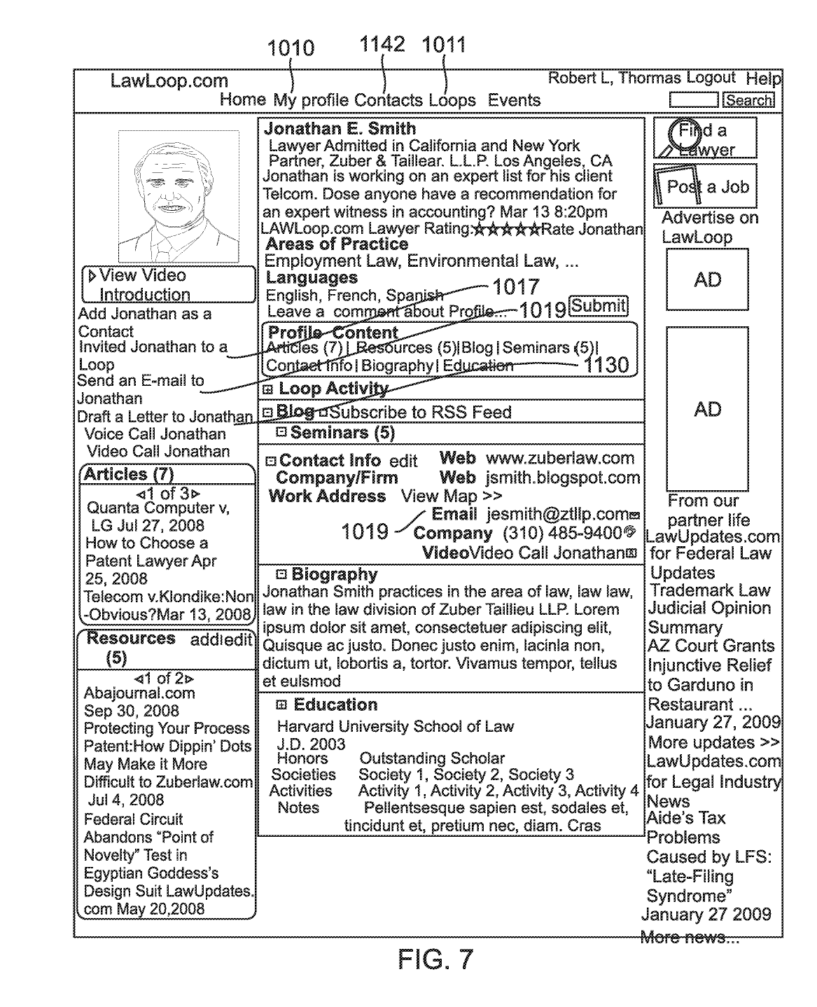

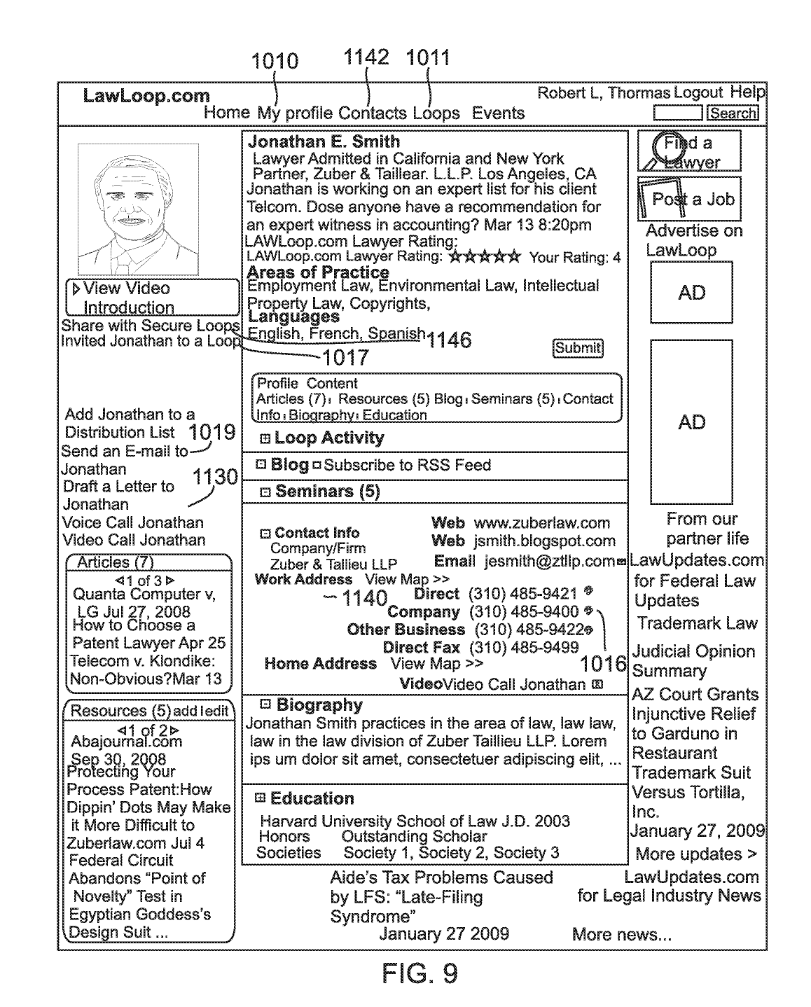

For example, a first member may access his/her member virtual identity by typing in a username and password at a login web page, as a user of social networking websites such as Facebook.com, Myspace.com or LinkedIn.com enters a username and password at a login web page to access his/her member virtual identity. Upon doing so, the web pages of the member's virtual identity appear, starting with a home page such as the web page depicted at FIG. 5 (also referred to herein as “Home Page”) to appear. The member may access his/her profile (profile of a member or “member profile” meaning the web pages of a member's member virtual identity that are partially or wholly visible to one or more other members of the community, often including contact information of the member, such as but not limited to business address, home address, business phone number, home phone number, mobile phone number, business fax number, home fax number, email address, etc., as the term “profile” is commonly understood in the online social networking industry) by clicking on the “My Profile” link at 1010, causing a web page of the profile such as the web page depicted at FIG. 6 (also referred to herein as “Profile—View By Owner,” where “owner” means the first member referenced above to whom the member virtual identity corresponds) to appear. Profile—View By Owner can differ from the versions of the Profile that are visible to one or more other members (i.e.: other than the Owner). For example, members other than the owner who have not been added as contacts (“contact” having a meaning analogous to “friend” on Facebook.com or Myspace.com, or to “connection” on LinkedIn.com, as the term “contact” is commonly understood in the online social networking industry) may see the version of the profile depicted at FIG. 7 (also referred to herein as “Profile—View by Members Who Are Not Contacts”), which might differ from Profile—View By Owner, for example, in that Profile—View By Owner can include links that allow the owner to add, delete or edit content on his/her profile, and the web page depicted in FIG. 9 (also referred to herein as “Profile—View by Members Who Are Contacts” might not; and in that Profile—View by Members Who Are Contacts may include an “Add Jonathan as a Contact” link, while the Profile—View By Owner might not.

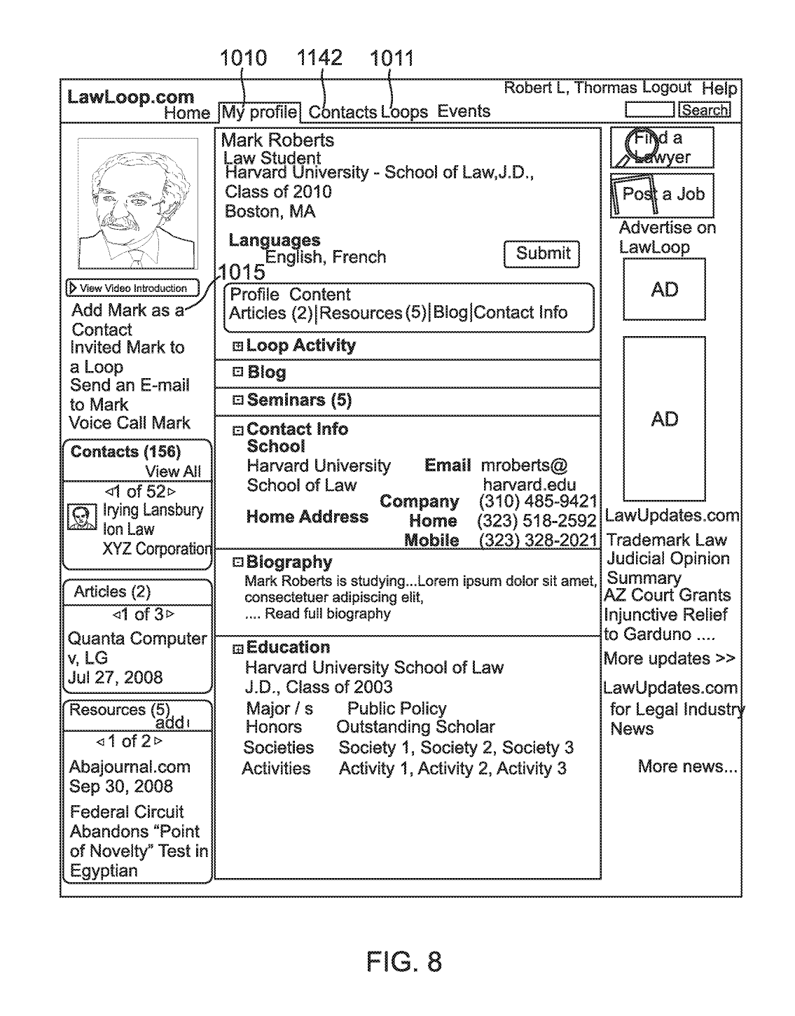

The member, being a first member, may add a second member as a contact, whereby the second member would be a contact of the first contact (and vice versa), such that, for example, the first member could view additional and/or alternative web pages and/or information (e.g.: which additional and/or alternative web pages and/or information are created and selected by the second member in accordance with methods disclosed and enabled in the prior art, which disclosures are incorporated herein by reference) of/on the second member's profile (and vice versa, respectively), for example, by clicking on the “Add Mark as a Contact” link 1015 on the profile of the second member depicted at FIG. 8 (also referred to herein as “Member Profile of Second Member—Viewed By Owner”), and thereby delivering a message (e.g.: via email, electronic message, instant message, or another social networking functionality of the community) to the second member allowing the second member to “accept” the request (i.e.: to effect the add and thereby make the requestor a member of the network), for example, by clicking on a link within the message. Having been added as a contact by the first member, the second member could see the version of the profile depicted at FIG. 9 (Profile—View by Members Who Are Contacts), which may differ from Profile—View By Members Who Are Not Contacts in FIG. 7, for example, in that Profile—View by Members Who Are Contacts in FIG. 9 can include additional contact information 1016 that is not included in the Profile—View by Members Who Are Not Contacts as shown in FIG. 7.

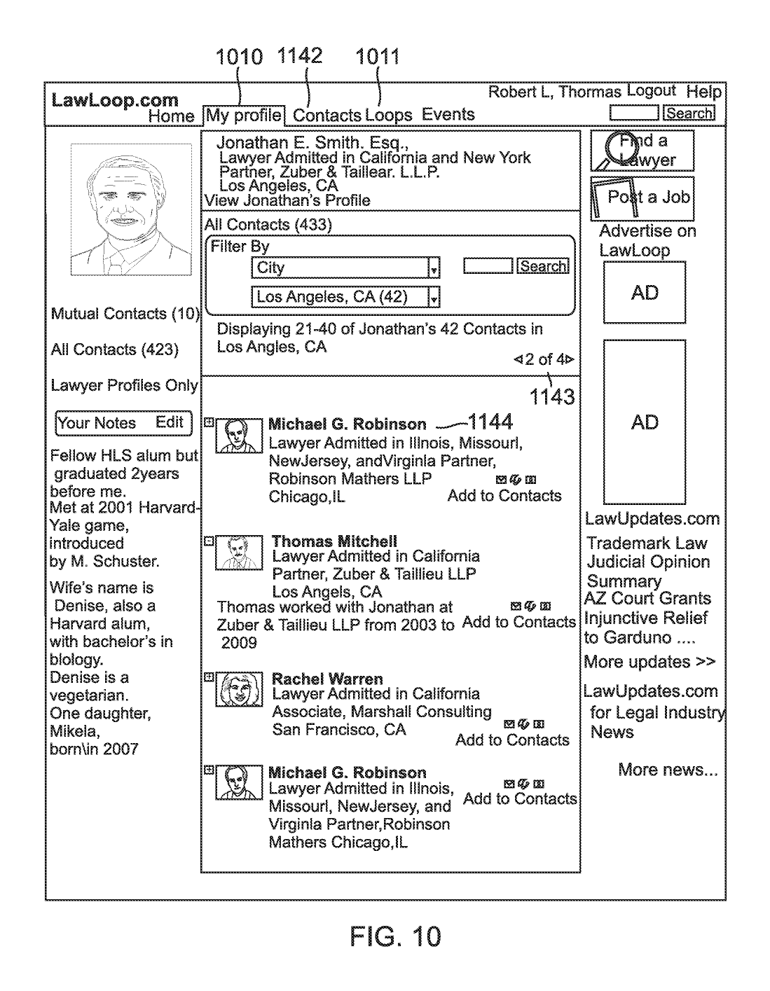

Furthermore, the first member, having logged in via the login account of his/her own virtual identity and accessed his/her own profile, could click on an icon 1142 of his own profile depicted in FIG. 6, thereby causing a web page depicted at FIG. 10 (also referred to herein as “Lists of Contacts”) displaying a list of links to the profiles of all contacts of the second member to appear, which links could be listed in alphabetical order based on the last name (or first name) of the contacts corresponding to the links, or based on many other ranking criteria. In an alternative embodiment, if links to all of the contacts do not appear on one web page (for example, if the links are for any reason too numerous to appear on one web page), the member may browse additional lists of contacts by clicking the icon 1143 on FIG. 10, causing in the instance of each such click a web page displaying a list of links to profiles of additional contacts to appear, with each subsequent list a continuation of the immediately preceding list. Of course, referencing the example of the previous paragraph, a link to the profile of the second member. would appear on this list or one of these lists, respectively. The first member can click on a link 1144 on FIG. 10, which link links to the profile of the contact corresponding to the link, thereby causing the profile to appear.

Examples of member virtual identities are widespread in the prior art. For example, online representations consisting of a user's login account, and the user's associated web page/s, on social networking websites such as Facebook.com, Myspace.com and LinkedIn.com, are each member virtual identities for the purposes of the present invention.

The members of the online community are capable of assembling into networks and sub-networks. These networks allow members to come together interact with each other via the social networking functionalities. An important feature of the present invention is that networks may be exclusive to certain members but not others, so that networks exclude at least one member in the online community. This allows for a collaborative work environment that provides members with the ability to work together on projects, and to communicate with one another, in situations where some members of the online community cannot or should not participate. For example, lawyers who are members and included with a network or sub-network in which they are working on a set of documents for a client or clients must know that they are not sharing confidential information with members who cannot have access to that confidential information. Therefore, this network or sub-network will exclude other members to protect the confidential nature of the collaboration among members of that network.

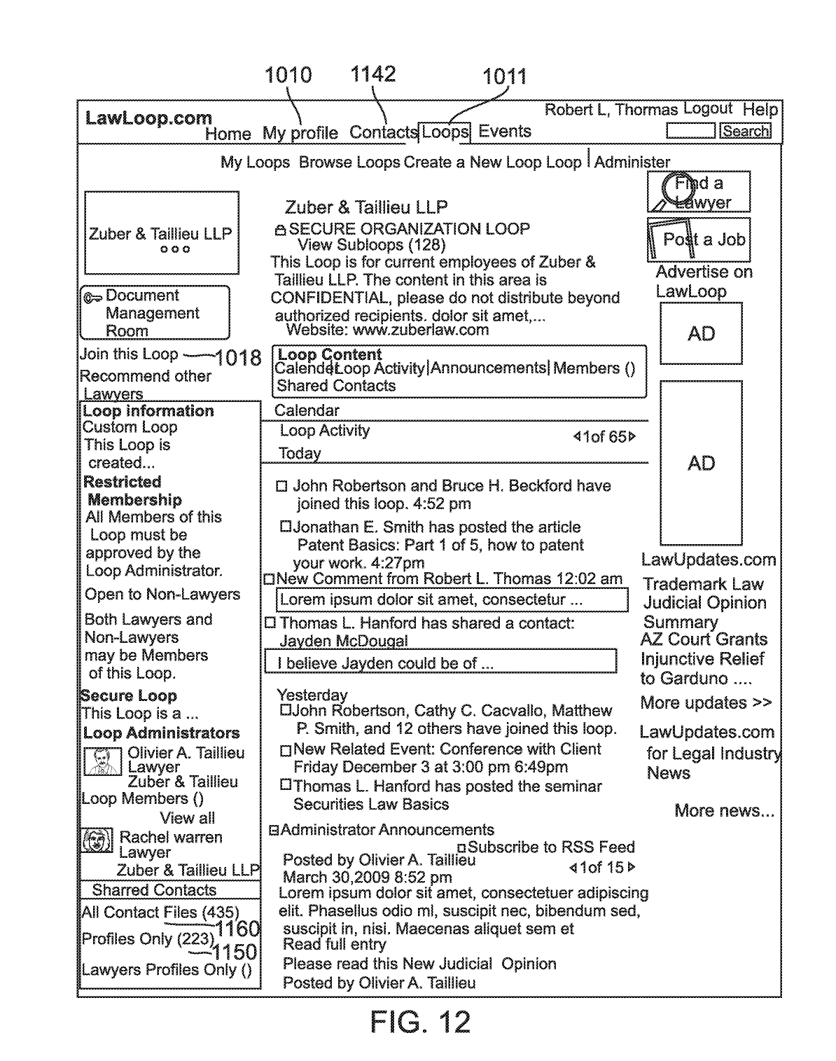

Members may assemble into a network based on a variety of characteristics and via a variety of methods. For example, a network administrator of a network may create and maintain a network, and may “add” members to the network (i.e.: incorporate members into the network), for example, referencing the example above, by clicking the “Invite Jonathan to a Loop” icon 1017 on the member virtual identity at FIG. 7. As another example, a network administrator of a network may invite a member to be added to the network, again referencing the example above, by clicking the “Invite Jonathan to a Loop” icon 1017 on the member virtual identity at FIG. 7, thereby delivering a message (e.g.: via email, electronic message, instant message, or another social networking functionality of the community) to the corresponding member allowing the member to “accept” the invitation (i.e.: to effect the add and thereby become a member of the network), for example, by clicking on a link within the message. As another example, a non-member of a network may request to join the network by clicking on an icon 1018 on the network virtual identity of the network at FIG. 12, thereby delivering a message (e.g.: via email, electronic message, instant message, or another social networking functionality of the community) to the network administrator of the network allowing the network administrator to “accept” the request (i.e.: to effect the add and thereby make the requestor a member of the network), for example, by clicking on a link within the message.

Exclusion from a network may be achieved in a variety of different ways. For example, exclusion from a network may be achieved by a network administrator's refusal to add a member to a network, refusal to accept a member's request to be added to the network, or “removal” of a member (i.e.: a revoking of a member's membership in the network) previously added to the network. Any other means of including or excluding members from participating in a network or sub-network are also contemplated by and included within the scope of the present invention. Of course, a member may also effect non-membership in the network by refusing to request addition to the network, refusing to accept an invitation to join the network by a network administrator of the network, or by removing himself/herself from the network.

Other social networking functionalities are also available to members in the online collaborative work environment. The social networking functionalities are available to members remotely (for instance, social networking functions enabled by software saved to servers remote from the members that allow members to manage virtual profiles and other web pages and aspects of the collaborative work environment saved on servers remote from the members). Examples of social networking functionalities include real-time communication functions that allow members (including, in particular, professionals who require communication functions in the course of collaborating within the present invention) to quickly and efficiently communicate with each other. These communication functions include, but are not limited to, on-line video conferencing, on-line voice conferencing, emailing, on-line messaging, instant messaging, text messaging, calendaring, and message posting. All of these occur in the context of the collaborative work environment and may occur within one or more networks, particularly where confidential information is being discussed and where one or members are excluded from the network.

Social networking functionalities may be accessed via a single click of an icon. Icons representative of social network functionalities may be found on a member virtual identity, on a network virtual identity, or both. A member may select a social networking functionality from his or her member virtual identity by clicking on an icon. For instance, a member may click on the icon 1019 on the member profile at FIG. 7 to initiate an email to Jonathan (which email could appear in a pop-up window, enabled by the Email Tool described below, in accordance with disclosures in the prior art, which disclosures are incorporated herein by reference). Note that the icon 1019 may appear in different forms on the same page, as shown in FIG. 7. Similarly, a member may select a social networking functionality from a network virtual identity of a network to which he or she is a member. Because member and network virtual identities have visual representations via a graphical user interface, members can navigate toward iconic representations of the social networking functionalities. Members may also access the social networking functionality via other methods, such as for example, via pull-down menus. Of course, other methods of accessing social networking functionalities are contemplated and within the scope of the present invention.

Further social networking functionalities are also subject to the same principles, so that members of sub-networks can freely assemble to communicate and/or collaborate separate from a main network to which they are members, and can exclude members. Other examples include but are not limited to emailing systems, instant messaging systems, and video conferencing systems.

Other details, aspects and functions of social networking functionalities, including but not limited to those relating to the addition and removal of contacts, the creation and maintenance of online social networks by network administrators, and the addition and removal of members of online social networks, are thoroughly disclosed in the prior art, and these disclosures and are incorporated herein by reference.

### Document Management Functionalities

Document management functionalities are also available to members in the collaborative work environment. One example of a document management functionality is the ability to create documents (i.e.: “document” meaning an email, a word processing document (e.g.: a letter, a fax), a spreadsheet, a presentation (e.g.: a Power Point® presentation), an image (e.g.: an Adobe Acrobat® image, a digital photograph), or any other type of document as the term “document” is used in the software application industry). Another example of a document management functionality is the ability to edit documents. Other examples of a document management functionality are the ability to delete documents, to save documents, to organize documents, to file documents, to access documents, to send documents, to receive documents, and to share documents.

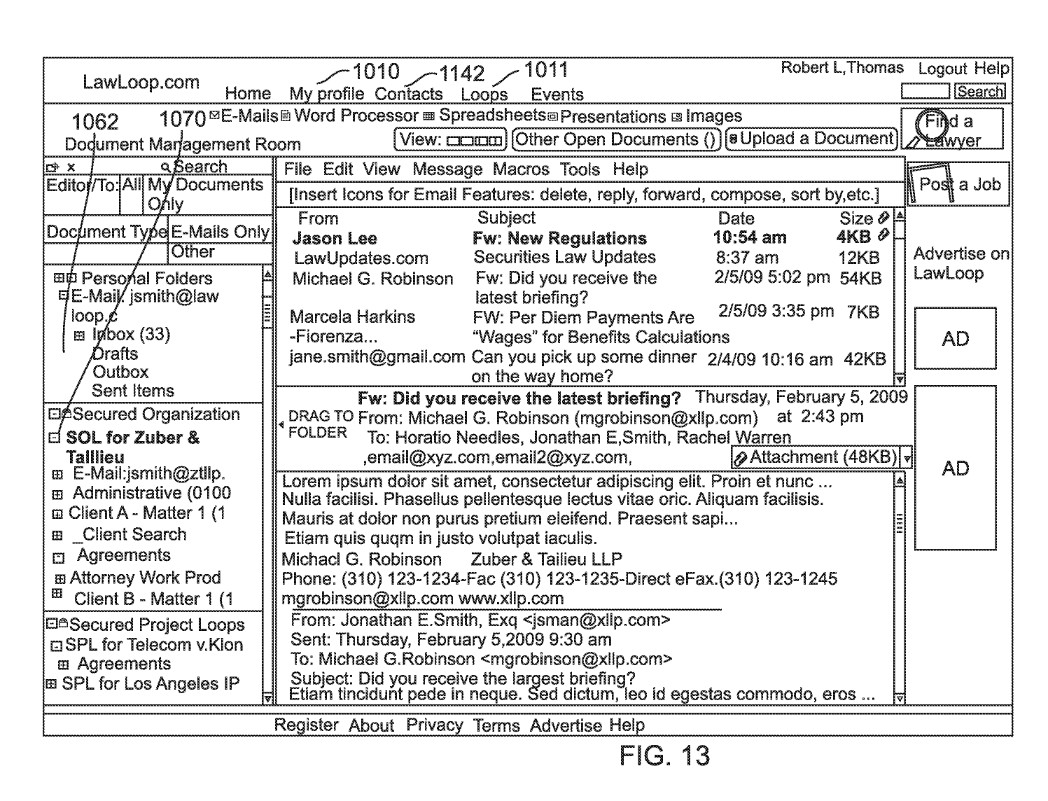

The document management functionalities are accessible to members via a document management tool that allows members to remotely and securely manage (i.e.: “manage” means to create, edit, delete, save, organize, file, access, send, receive, and/or share) documents. The document management tool comprises online software applications available to members that allow members to manage documents remotely (for instance, software applications saved on servers remote from the member that allow the members to manage documents saved on servers remote from the members), including a calendaring tool such as Outlook®, an email tool like Outlook® or Zoho® Mail, a word processing tool such as Word® or Zoho® Writer, a spread sheet tool such as Excel® or Zoho® Sheet, a presentation tool such as Power Point or Zoho® Show, an image viewing tool such as Adobe Acrobat®, a document filing tool like Interwoven® or Zoho® Docs, and/or a contact file management tool such as Outlook® (“contact file” meaning a file containing/storing contact information, but not being associated with a virtual identity, as such term “contact file” is commonly understood in the contact file management software application industry). The document management tool allows a member to access, work with, and manage a system of windows (i.e.: “window” meaning a portion of a computer monitor screen typically wholly or partially separated from other portions of the screen by a graphic border or other means) and folders for managing documents, such as the document management tool depicted at FIG. 13.

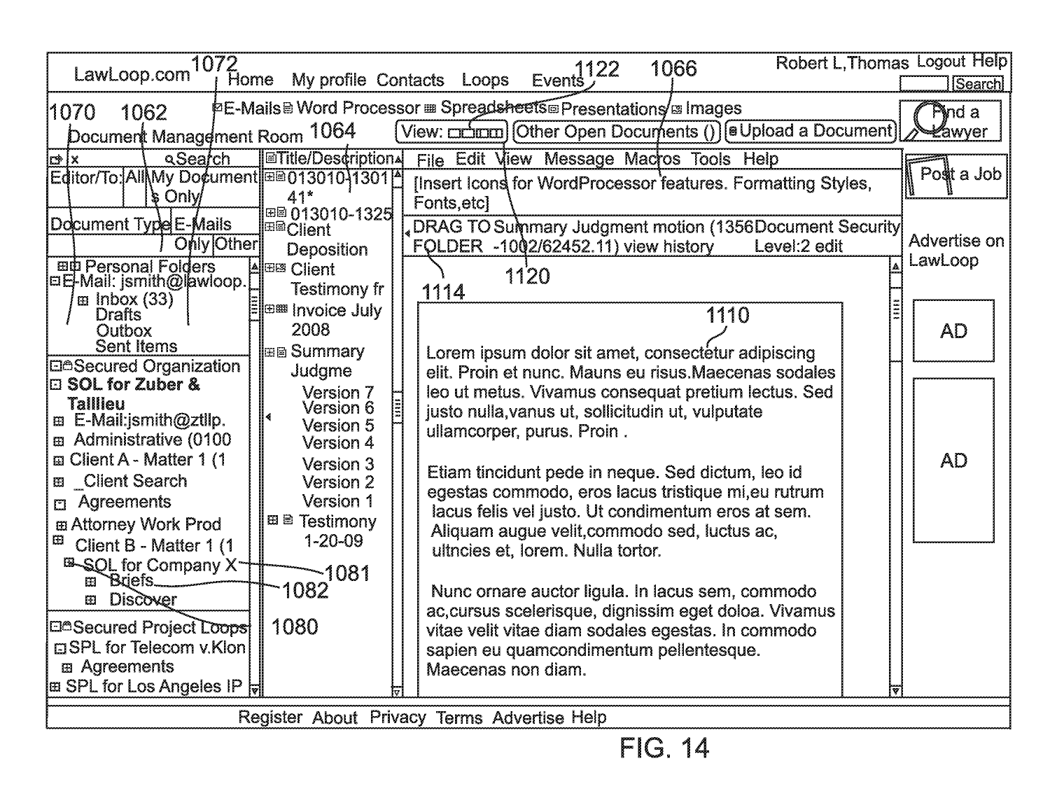

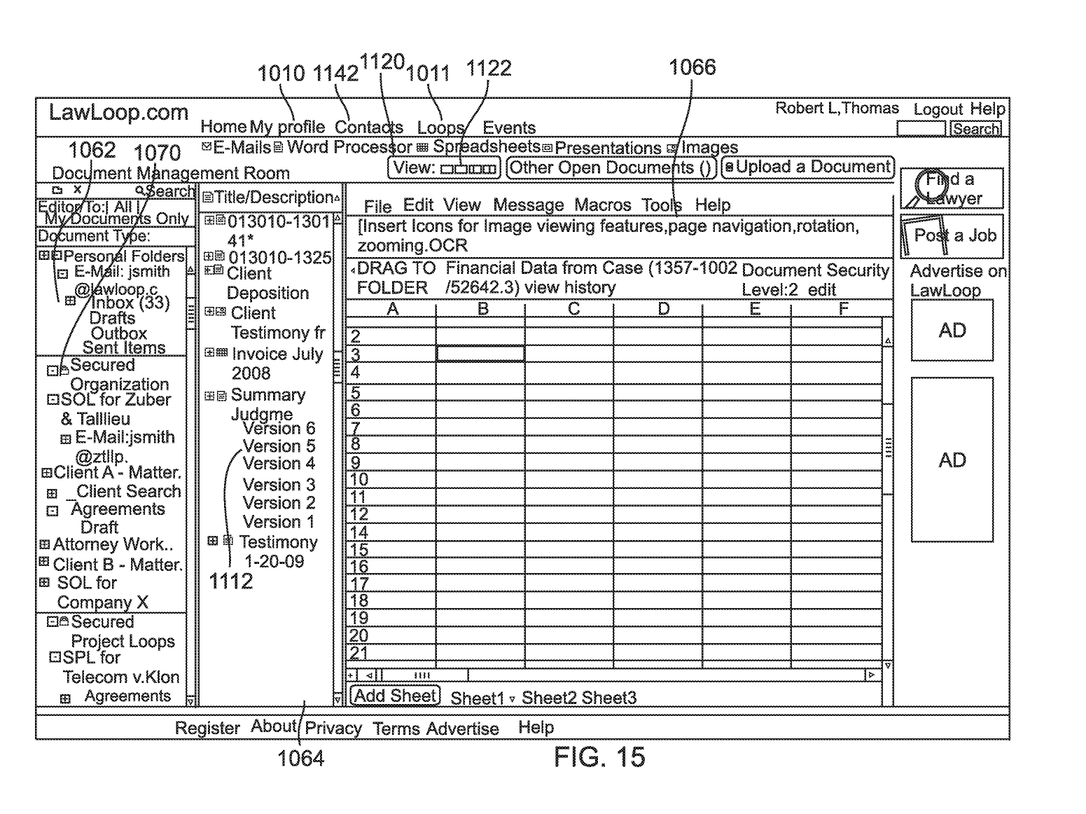

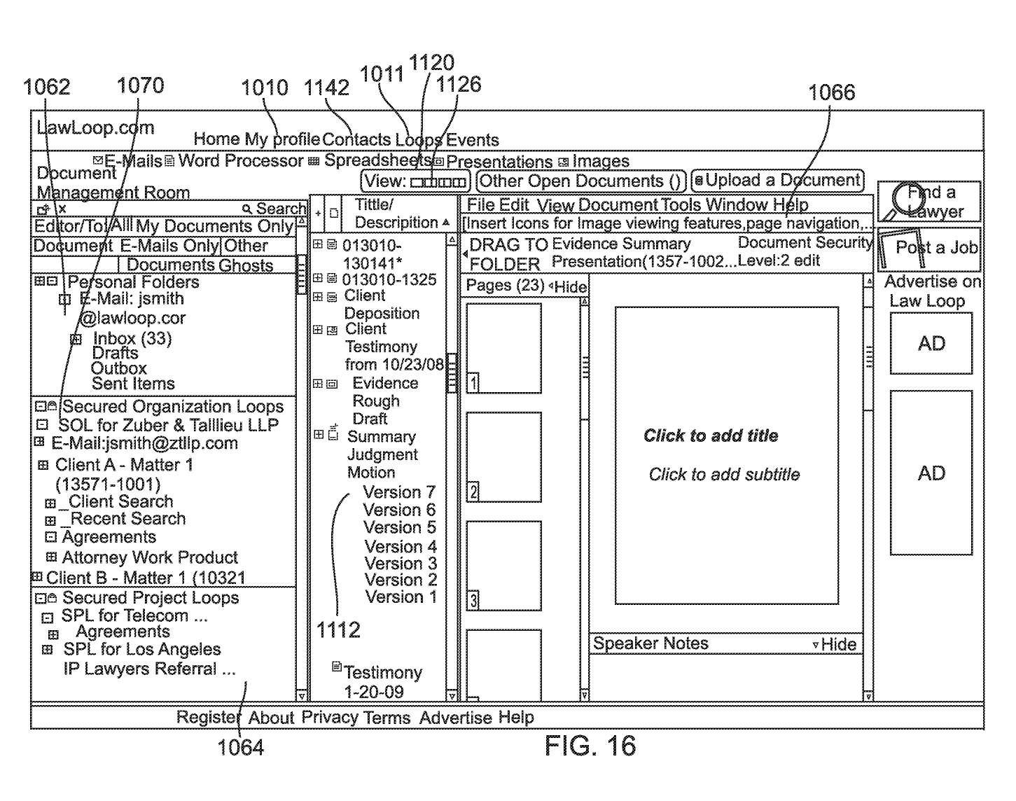

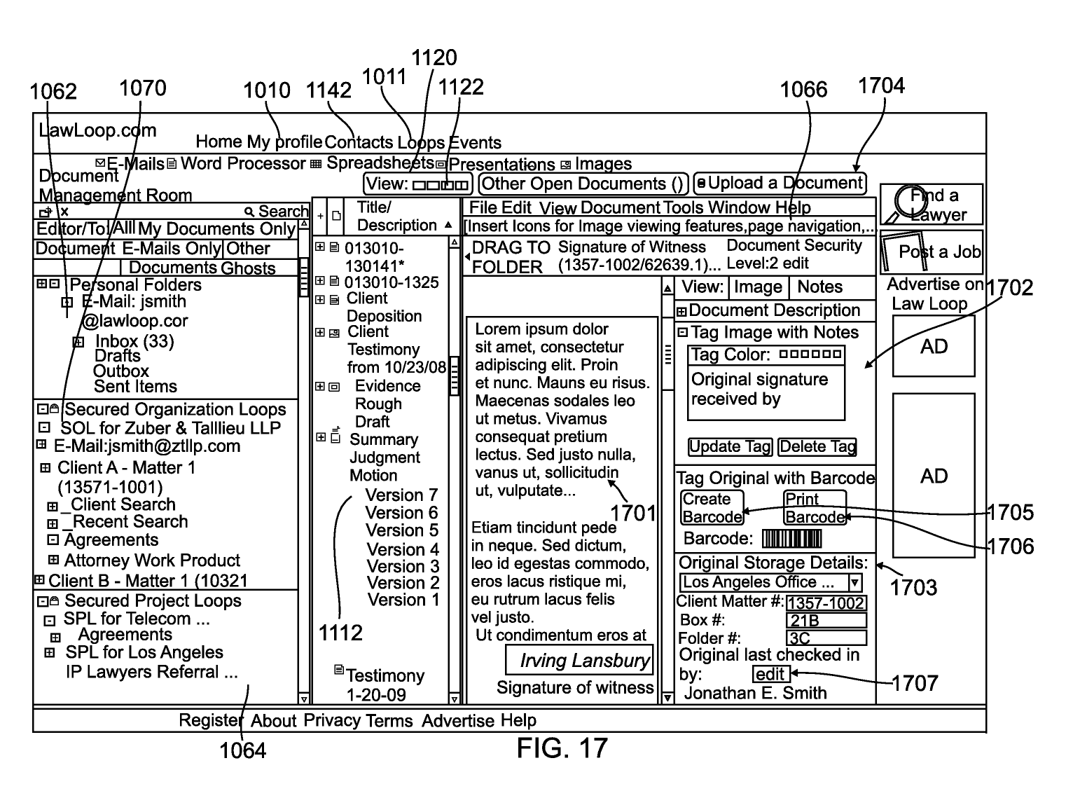

A member described in the example above who accessed his/her virtual identity by typing in a username and password at a login web page could access the document management tool from his/her Home Page by clicking on any of the link 1020, the link 1030, the link 1040, the link 1050 or the link 1060. For example, the member could click on the “Emails” link at 1020, causing a document management tool like the one depicted at FIG. 13, to become active, wherein a document filing tool and an email tool are active. As another example, the member could click on the “Word Processor” link 1030, causing a document management tool like the one depicted at FIG. 14, to become active, wherein a document filing tool and a word processing tool are active. As another example, the member could click on the “Spreadsheets” link 1040, causing a document management tool like the one depicted at FIG. 15, to become active, wherein a document filing tool and a spreadsheet tool are active. As another example, the member could click on the “Presentations” link 1050, causing a document management tool like the one depicted at FIG. 16, to become active, wherein a document filing tool and a presentation tool are active. As another example, the member could click on the “Images” link 1060, causing a document management tool like the one depicted at FIG. 17, to become active, wherein a document filing tool and an image viewing tool are active.

Other details and aspects of these document management functionalities, and these software applications, are thoroughly disclosed and enabled in the prior art, and these disclosures are incorporated herein by reference.

### Coding Functionality

Members also have the ability to view documents using an image viewer or image viewing tool. The image viewing tool is a tool that allows the members to view documents in portable document format (“PDF”), JPEG, GIF, TIFF or other popular image formats. Although PDF files will be discussed throughout this description, a person of skill would recognize that the benefits of this invention are equally applicable to other types of image files and may therefore be adapted for use with a number of image viewing tools. It is an object of this invention to provide a method whereby electronic and hard copy versions of the documents are associated with each other and with a physical storage location of the hard copy document.

Documents viewed with the image viewing tool are most likely to be electronic copies of a hard copy document. For example, a member who receives a letter in the mail would likely convert the letter to an electronic document using an electronic scanner in order to maintain an electronic copy of the letter. Electronic scanners are well known in the art, and typically capture the documents as an image in PDF, JPEG, or TIFF format. The member would thereafter typically place the original hard copy document in a file cabinet or similar hard copy storage system and file the electronic copy using a document management tool.

In one embodiment of the invention, upon scanning the hard copy of the document, the member would then be able to access and view the document using the image viewing tool as depicted in FIG. 17. The image 1701 is presented in one portion of the user interface, while the member is presented with a number of image coding options 1702 in another portion of the interface. As shown in FIG. 17, the coding functionality is shown in an adjacent frame 1702 in the interface. The user is here allowed to tag the image with notes, to input information about the physical location of the hard copy document, and to create and print a code corresponding to that document. As used herein, the term “code” refers to a group of numerals, letters, symbols or shapes that convey information about the hard copy document and the electronic document. For example, the code may be an alpha-numeric string of characters, a barcode, or some other human- or machine-readable symbols. Other codes known to those of skill in the art may be suitable for use with this invention, even though not fully set forth herein.

As shown in FIG. 17, the member can input the original storage details 1703 to associate a hard copy physical location, such as “Los Angeles Office,” “Box #,” “Folder #,” and the like with the electronic document. The member can choose additional information based on the needs of the member. For example, it is contemplated that an alternative embodiment might include location information for a storage shelf, filing cabinet, or safe name. Other forms of location information in accordance with this disclosure are within the scope of this invention, although not fully described herein.

In the preferred embodiment, the original storage details 1703 are associated with the hard copy document and electronic document at the time the document is created or received by the member. Typically, the member (or someone working on behalf of the member, such as a secretary or assistant) will scan the original hard copy document using a scanner, converting the document into an image file in the process, and using OCR to associate metadata and text with the image file, as described below. The image file is then uploaded into the document management system using the “Upload a Document” button 1704. Alternative methods of uploading a document are discussed elsewhere in this application.

Upon uploading the image file, the member will view the image in the image viewer shown in FIG. 17. At this point, the member selects the “Create Barcode” button 1705 in order to associate a barcode with the hard copy document and the electronic version of that hard copy document. The social networking community assigns a barcode to the document currently being viewed.

The member will also at this point assign identifying information in the original storage details 1703 portion of the image viewer. In the example shown in FIG. 17, the member has assigned an office (i.e., Los Angeles Office), corresponding to the particular office (or office address) where the document is stored, a client matter number (1357-1002), corresponding to the matter to which the document is related, a box number (21B), corresponding to the box containing the folder, and a folder number (3C), corresponding to the folder where the document is stored. Each of these categories indicate the physical location where the hard copy document is or will be filed by the member. The information now associated with the document allows the member—and all members with access to the document—to instantly know the physical location of the hard copy of the document.

In a preferred embodiment, the member will next select the “Print Barcode” button 1706, which will cause a hard copy document containing the barcode assigned to the image to be printed for the member. The document containing the barcode may also contain a printed description of the location of the hard copy document. The document containing the barcode may also contain an image of a representative page of the document to be filed in order to allow easier confirmation of the identity of the document to be filed (i.e., without having to remove the document containing the barcode). The image of the representative page may be a thumbnail image of an easily-recognizable page from the document, a full-size image of a portion of a representative page, or some other graphical representation of the document associated with the barcode.

In a preferred embodiment, the code assigned to the hard copy document is a function of a document number associated with the electronic document by the document filing system. By this is meant that the code is based off of the document number in some set way. Thus, a difference in the document numbers between two documents will result in a difference in the resulting code. For example, if the code is a barcode, it may be created or assigned by simply converting the alphanumeric document number to barcode form.

In a preferred embodiment, the document number is a unique combination of alphanumeric characters such as ABC123, 123456789, or similar, which is easily understandable by humans. In a preferred embodiment, the hard copy document displaying the code will also display the document numbers so that they may be read and understood by any person viewing the document. As described below, the user can scan the code to check a document in or out of the system. Alternatively, the user may type in the document number on a keyboard or keypad to check-in or check-out the document, or to pull up an image of the document on the image viewer of this invention.

The document containing the code is preferably affixed to the hard copy document such as by stapling or clipping the document containing the code as a cover sheet to the original document. In an alternative embodiment, the member may also print a hard copy of the code, such as on a sticker, to affix on the hard copy of the document. The code on the sticker and the code displayed in association with the electronic document in the image viewer are identical.

Because the electronic and hard copy versions of the document are linked by a common code, members with access to one version of the document are able to access the other version of the document. For example, a member who has the hard copy version of a document containing a barcode in hand can scan the barcode using an electronic code reader. Scanning the hard copy barcode will give the member access to the electronic version displayed on the image viewing tool of the social networking community.

Similarly, a member who is viewing the electronic version of a document will be presented on screen with the code and location information. As described above, the location information displayed tells the member where the hard copy version of the document can be located.

By this method, information describing the physical location of the original hard copy document is permanently associated with both the original hard copy document and the electronic version of the document. This is beneficial to the member for a number of reasons.

In a preferred embodiment, a member who views the image displayed with the image viewer can easily locate the hard copy document by recording the original storage details or by printing a copy of the barcode via the “Print Barcode” button 1706. The member can present the printed page bearing the barcode to a filing clerk who will then scan the barcode with a barcode reader and retrieve the original hard copy document based on the information associated with that barcode. In a preferred embodiment, scanning the barcode document will activate the image viewer containing the information shown in FIG. 17, including the electronic image of the document and the original storage details 1703.

Second, an original hard copy document that is misplaced may be easily re-filed by anyone who finds the document. For example, a member may retrieve the original hard copy document for review at a meeting, leaving the hard copy document in a conference room at the conclusion of the meeting. Any person who then comes across the document can then scan the barcode located on the affixed cover sheet to determine where the document ought to be filed. Without this code, a person who finds such a document would often be without guidance as to the proper home for the document.

It is an object of the invention to also associate the hard copy document and the electronic image of the document with the identity of the last person to have physical custody of the hard copy document. In the embodiment shown in FIG. 17, the original storage details 1703 portion of the image viewer indicates that the document was last checked in by Jonathan E. Smith, and provides a link to Smith's member profile. This check-out and check-in procedure operates to provide an additional safeguard against valuable or irreplaceable original documents being misplaced.

According to this embodiment, member Jonathan E. Smith wishes to check out the document 1701 displayed in the image viewer. Smith would then print out the barcode sheet as described above in order to retrieve the hard copy document from the file room or storage cabinet. In the preferred embodiment, Smith would then log in to the social networking community using his own member profile and scan the barcode on the affixed cover sheet using a scanner connected to the social networking community. The image viewer then displays the image as shown in FIG. 17. Smith selects the “edit” button 1707 and is presented with a number of actions such as “check in document” or “check out document.” In this example, Smith would select “check out document,” which would automatically record the time and date that Smith scanned the document, indicating the time when Smith took physical possession of the hard copy document. Thereafter, any other member who views the image of the document is informed that the hard copy document has been checked out by Smith, and is provided a link to Smith's member profile.

Preferably, Smith returns the hard copy document when he is finished examining the hard copy document. Accordingly, Smith would log in to the social networking community using his own member profile. Next, Smith scans the barcode on the affixed cover sheet and selects the “edit” button 1707 as before. This time, Smith would select “check in” from the options presented. The community then records that Smith has checked in the document and displays the same information to all members viewing the electronic image of the document. As shown in FIG. 17, the system displays that the original was last checked in by Jonathan E. Smith. Preferably, Smith (or someone working on his behalf) then returns the hard copy document to the proper box and folder associated with the hard copy document.

In another embodiment, any other member with access to the proper network may return and check-in the document on Smith's behalf, such as when Smith misplaces the document after a meeting. To do so, the person acting on Smith's behalf would scan the document and choose the “edit” button 1707, selecting “check-in.”

By associating a checked-out hard copy document with a member profile as described above, the system permits other members to directly contact the current custodian (i.e., Smith) for access to the document when the hard copy document has been checked out. This is a drastic improvement over prior art document management systems which typically require a person attempting to locate a document to email or call every person working on a project to ask whether they have the document.

In a preferred embodiment, the code is a barcode. As used herein the term “barcode” refers to not only the traditional barcode familiar on commercial product packaging, but also to other types of barcodes familiar to those of skill in the art. For example, a “barcode” includes Universal Product Code (“UPC”), Codabar, Code 93, Code 128, Codablock, PDF417, Datamatrix, High Capacity Color Barcodes, Quick Response (QR) Codes, MaxiCode, ShotCode, etc. Alternative embodiments of the invention employ other machine readable codes, such as the MICR font used to convey checking account information on checks.

In one embodiment of the invention, electronic scanning of a hard copy document is also accompanied by optical character recognition (“OCR”) of the text in the hard copy document. The OCR process is well-known in the art and is used to associate images of printed or written characters on a page with metadata or text corresponding to those images of text. The text extracted from the hard copy of the document is automatically associated with the electronic copy of the document. The member using the image viewing tool will thus be able to search for text within the document, or to search throughout a database of documents for documents containing a particular string of text. For example, a member might search for a string of text that says “confidential information.” Each instance of the term “confidential information” appearing in the viewed document will be displayed. Likewise, each instance of the term “confidential information” appearing within a selected database will also be displayed. The ability to search for text within a document or within a database will be readily understood by those of skill in the art.

In an alternative embodiment of the invention, the document associated with a code originates as an electronic document. For example, a member can create a document using the word processing tool described herein, and then convert the document directly from word processing document to image format, bypassing the creation of a printed hard copy document. Alternatively, the member may receive an image file from another person via email, CD, or DVD. In this situation, there is no code cover sheet or sticker to affix, no hard copy document to scan, and no hard copy document to file. The member in this case skips the scanning steps described above and proceeds with uploading using the “Upload a Document” button 1704.

As when the document originates as a hard copy document, the member in the preferred embodiment selects the “Create Barcode” button 1705 in order to associate a barcode with the image file, inputting the physical location information in the original storage details 1703 section of the image viewer. However, at this point, the barcode is associated with only an electronic version of the document. The member may then select the “Print Barcode” button 1706 to print the cover sheet containing the barcode associated with that document. The member may then print a copy of the electronic document and affix the cover sheet to the printed hard copy document, which may be filed in a physical location. Thereafter, the printed hard copy document may be checked in and checked out as described above.

In this situation (electronic document converted directly to PDF or other image format), the text associated with the electronic document is automatically associated with the PDF document, as is commonly understood in the art. Accordingly, documents converted directly to PDF (or similar image files) will also be text searchable.

In the situation where the member receives a non-searchable image file via email, CD, or DVD, the member may use an OCR tool to append text information to the file, thus making the electronic file text searchable.

Finally, additional hardcopies of any document associated with a code as described herein may be printed using the image viewer. Upon printing, the member may be presented with the option of printing the code associated with the document, either as a cover sheet or on the document itself, as in a header or footer.

It should be understood that there may be additional methods of associating the code with the hard copy document not described herein. Although this description focuses on an affixed cover sheet, stickers, and printing the code in a header or footer, those of skill in the art may incorporate additional methods in keeping with the scope of this invention.

### Integrative Functionalities

The online collaborative work environment of the present invention offers several integrative functionalities that overlay and are made possible by the combination of various social networking functionalities and document management functionalities. Integrative functionalities provide the mechanism for performing tasks within the collaborative work environment. These integrative functionalities allow members to collaborate within specific modules to work on projects together more easily, efficiently and effectively. Integrative functionalities allow members to manage (i.e.: “manage” meaning to create, edit, delete, save, organize, file, access, send, receive, and/or share) documents within a secure document management system more easily, efficiently and effectively.

Among the integrative functionalities is the ability for members to easily assemble in a network remotely sharing a document or group of documents or a “room” (i.e.: “room” meaning a group of folders of documents, as the term “folder” is commonly understood in the industry in the context of document filing systems such as Interwoven®), typically stored on a server at a location remote from at least one (and typically most or all) of the members of the network. More particularly, a network administrator can create a network of members, each having member virtual identities, in accordance with the disclosures above, or in accordance with other means for forming networks on social networking websites such as Facebook.com, Myspace.com or LinkedIn.com. This integrative functionality of the present invention allows this network of members to easily, efficiently and securely share a room of folders of documents. For example, FIG. 14 shows a window 1062 displaying rooms of folders of documents including a room 1070 of folders of documents, which room 1070 is the folder 1072 and all of its subfolders, a window 1064 displaying links to documents stored in a folder 1100, which folder is stored in Room 1070 labeled “SOL of Zuber & Taillieu LLP,” and a window 1066 displaying the contents of document 1110 linked to by document link 1112. A member of the network may view the contents of any other document stored in folder 1100 by clicking the corresponding document link in window 1064, thereby causing the contents of the corresponding document to appear in window 1066. Similarly, a member of the network may view the contents of any other folder of room 1070 by clicking on the folder, thereby causing the document links to documents stored in the folder to appear in window 1064.

In one embodiment, the present invention contemplates a network of members comprising the attorneys and staff persons of a law firm, the network sharing a secure room 1070 of folders of documents of the law firm (i.e.: “secure” meaning that members and other persons who are not members of the network do not have access (or as complete access) to the room). Upon the hiring of a new attorney who is a member of the online social networking community, this integrative functionality allows the network administrator to grant the attorney the ability to use the document management functionalities described above to manage the room 1070 by simply adding the attorney to the network by, for example, simply clicking on an “Invite Jonathan to a Loop” icon 1017 on the attorney's member virtual identity at FIG. 7. Of course, this integrative functionality makes possible enormous efficiencies for the law firm. For example, referencing the foregoing example, the law firm added the newly hired attorney above without the need to incur the significant labor and capital costs typically associated with granting such a newly hired attorney access to, say, a secure server containing the documents shared by the law firm, such as, for example, the hours that it would have taken for technical personnel of the law firm to install on the attorney's computer the software applications required to allow the attorney to access the server and manage the documents. As another example, the law firm avoided the need to create a new login account for the newly hired attorney—rather, upon addition to the network, the newly hired attorney, by accessing the login account associated with his/her member virtual identity, has access to the online room 1070 shared by the network. Much as the receptionist at the entrance to the physical premises of the law firm recognizes the physicality of the attorney and grants him/her access to the physical premises, the network administrator recognizes the attorney's online member virtual identity, and grants the member virtual identity (and thereby the attorney) access to the online room 1070 shared by the network by simply adding the attorney to the network by, for example, simply clicking the “Invite Jonathan to a Loop” icon 1017 on the attorney's member virtual identity FIG. 7.

A further integrative functionality allows a member to share a first secure room of folders of documents with a first network of members and a second secure room of folders of documents with a second network of members with a single login account. For instance, referencing the example of the immediately preceding paragraph, the newly hired attorney who has been added to the law firm's network, being a first attorney, may be working on a litigation with a second attorney in the representation of a single client having a member virtual identity, and may wish to share one or more documents and/or folders with the second attorney having a member virtual identity and the client. Referencing FIG. 14, the law firm network being a first network, a second network administrator of a second network sharing a second secure room 1080 of folders of documents (i.e. which second secure room is (and which folders and documents therein are) not shared with members of the first network, or any other members, who are not members of the second network), which room 1080 is the folder and all of its subfolders, could add the first attorney, the second attorney and the client to the second network, thereby giving the first attorney, the second attorney and the client access to the second secure room of folders of documents. The first attorney, by accessing the login account of his/her member virtual identity, can, for example, manage document 1110, being a first document, of the first network by, for instance, accessing the documents of a folder 1100, being a first folder, shared by the first network and containing document 1110 by clicking on folder 1100, then accessing the contents of document 1110 by clicking on document link 1112, and then editing or otherwise managing the document; and may similarly, for example, manage a second document shared by the second network by, for instance, clicking on a second folder 1082 of room 1080 containing the second document, thereby causing documents links to the documents stored in the second folder (again, which folder of room 1080 is shared by the second network and not by the first network) to appear in window 1064, clicking on the document link to the second document to cause the contents of the second document to appear in window 1066, and then editing or otherwise managing the second document (such clicking, accessing, editing and managing in each instance above in accordance with methods already disclosed and enabled in the prior art in the context of, for example, document filing tools such as Interwoven® and word processing tools such as Word® and Zoho Writer®, which disclosures are incorporated herein by reference).

### Security and Access Control

The present invention contemplates that networks may erect methods of preventing some members from participating in a network. Additionally, members may be required to present identification credentials to enable a member virtual identity and/or to access certain networks. For example, to ensure a member is who they say they are, they may be required to properly present identification credentials, such as a password, to access or enable their member virtual identity. Many other methods of identity verification may be employed to ensure security is maintained. For example, verifying a member's identity may include, in addition to entry of a password (whether entered via text input, entered via image input, or entered orally), thumbprint verification, fingerprint verification, eye-scan verification, voice verification, or DNA verification.

Further security protocols may be used to ensure that only certain members be allowed to access certain networks. For example, a network of lawyers from separate law firms collaborating on a project may be required to prove they are members of one of the firms, either through a password, a digital certificate on the computer they are accessing the network from, or via any other known method of verifying access. Broader networks of lawyers not specific to a particular project may require proof of licensure of a country's or state's bar examiners or court system.

A network administrator may be assigned control over member access to the collaborative work environment and the networks therein. A network administrator may be assigned the ability to add or delete members from a particular network. One method of adding or deleting members is to click on an icon representative the member's virtual identity. A network administrator may also be add or delete members in bulk; one method of doing so it is to highlight several members' virtual identities and drag them to an icon representative of a network virtual identity.

### DETAILED DESCRIPTION OF THE CLAIMED INVENTION AS SHOWN IN ADDITIONAL FIGURES

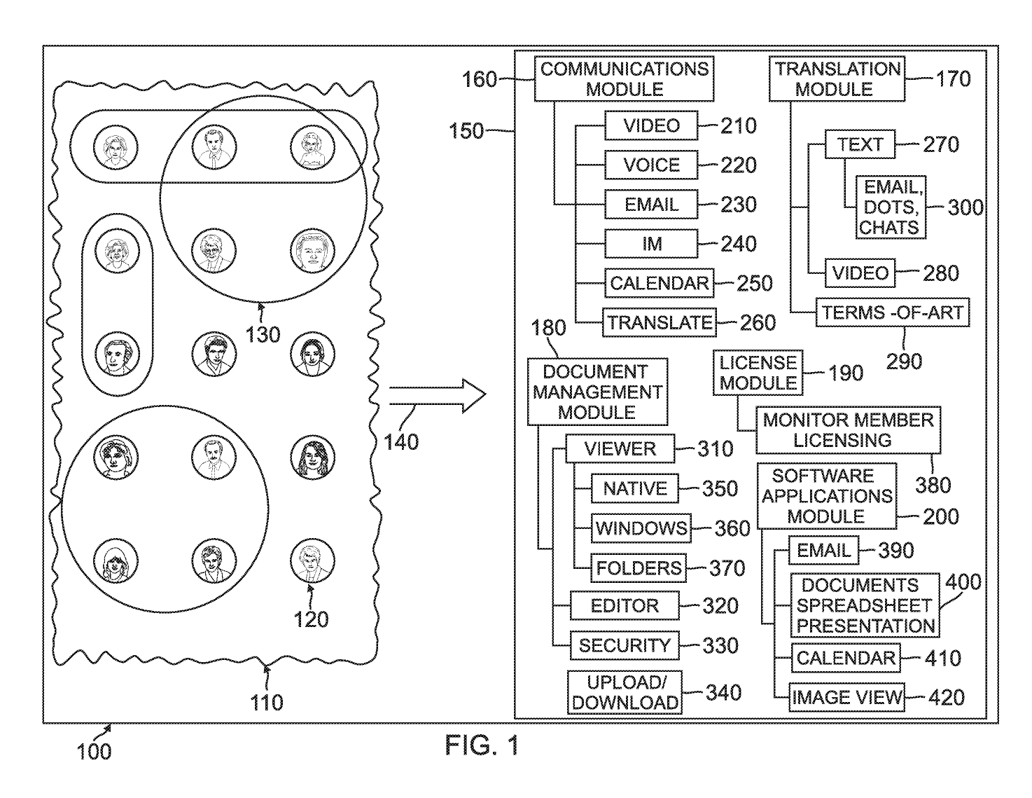

FIG. 1 shows a secure, network-based collaborative work environment 100 according to the present invention. The secure, network-based collaborative work environment 100 allows one or members 120 of an online community 110 to access and utilize several integrative functionalities 150 as fully described herein. The one or more members may be grouped together into one or more networks of members 130.

Members 120 of the online community 110 have an account with the online community 110 which defines a member virtual identity 640 associated with the member 120. The member's account and virtual identity 640 form a member profile which conveys information about the member 120. The member virtual identity 640 is an online representation of that member 120 and may take many different forms. For example, a member's 120 webpage or collection of web pages may be considered a member virtual identity 640. The member virtual identity 640 may be represented by an icon.

The plurality of integrative functionalities 150 available to the one or more members 120 includes at least a communications module 160, a translation module 170, a document management module 180, and a software applications module 200. At least one additional integrative functionality 150 includes a license module 190 which controls monitoring of licensing of the one or more members 120. License module 190 further includes a sub-module 380 for performing the task of license monitoring. Each of these integrative functionalities 150 include several sub-modules for executing various algorithms associated with the integrative functionalities 150 and allow the one or more members 120 to perform different tasks within the online community 110.

The communications module 160 of the integrative functionalities 150 includes sub-modules for video conferencing 210, voice conferencing 220, email 230, various forms of instant messaging 240, calendaring 250, and translation 260. The translation module 170 of the integrative functionalities 150 includes a text sub-module 270 that further includes capabilities for translating emails, documents, and chats 300. Translation module 170 also includes a video translation sub-module 280 and a terms-of-art translation sub-module 290.

The document management module 180 includes several sub-modules designed to facilitate collaboration amongst members 120 who are working with various documents. The document management module 180 includes a viewer sub-module 310 that has further sub-modules that enable the viewing of native documents 350, provide various options for windows management 360, and various options for folder management 370. The document management module 180 also includes an editor sub-module 320 and a security sub-module 330. Addition sub-modules for the document management sub-module 180 include an upload/download sub-module 340 that manages the upload and download of documents within the online community 110.

The software applications module 200 includes several sub-modules offering software applications to the one or more members 120. Each of these sub-modules allows the one or more members 120 to conduct various activities within the online community 110. For example, the software applications module 200 includes an email sub-module 390 which allows a member 120 to access email applications for managing, sending, receiving, deleting, storing, and aggregating email. The document, spreadsheet, and presentation sub-module 400 allows a member 120 to access one or more applications for word processing, spreadsheeting, and preparing presentations. A calendar sub-module 410 allows access to applications for maintaining a calendar of important dates and meetings. Many additional applications sub-modules are contemplated with the present invention. Another such sub-module may be an image viewing sub-module 420 which allows a member 120 to easily view documents with a number of different applications for viewing different kinds of documents, particularly in connection with the document, spreadsheet, and presentation sub-module 400. Note that the image viewing sub-module 420 may be different than the viewer sub-module 310 associated with the document management module 180.

It is to be noted that many different applications are contemplated for the email sub-module 390, the document, spreadsheet, and presentation sub-module 400, the calendar sub-module 410, the image viewing sub-module 420, and the other applications sub-modules contemplated by the present invention.

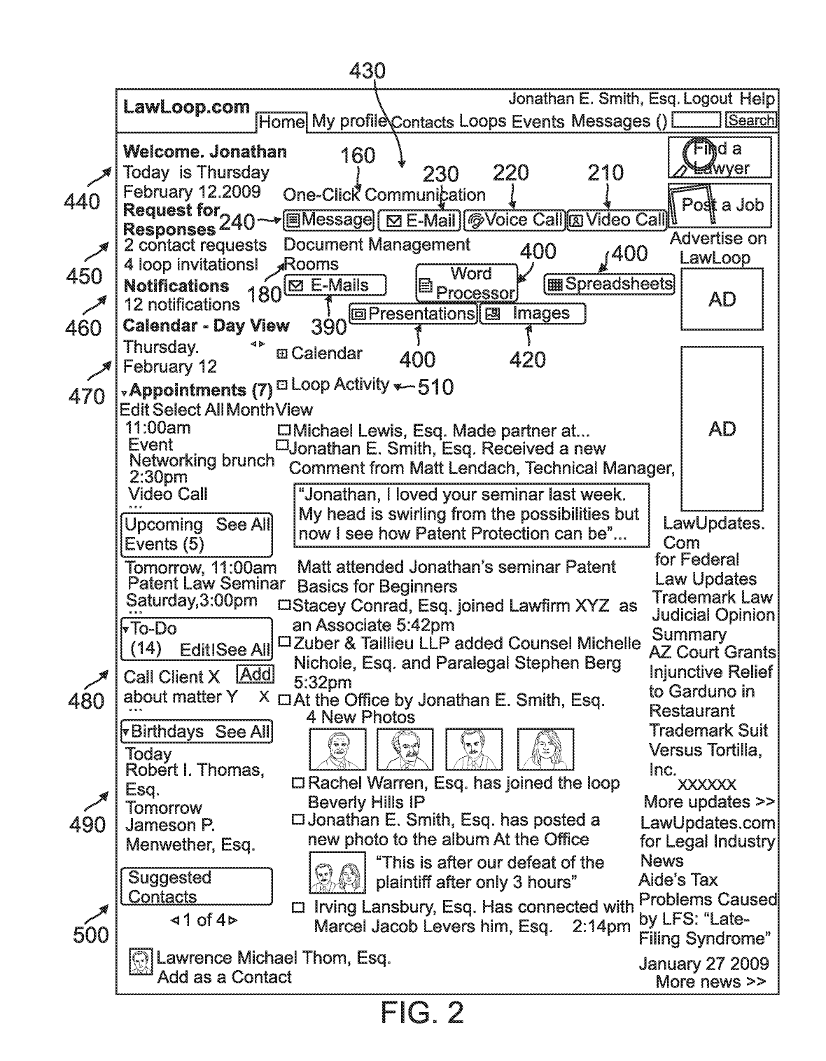

FIG. 2 shows an exemplary graphical implementation of one aspect of the present invention. In FIG. 2, a member's 120 home page on the graphical user interface 140 is depicted. The member's 120 home page 430 of the online community 110 on the graphical user interface 140 shows one embodiment of several integrative functionalities 150 accessible to the member 120.

At the home page of the online community 110 on the graphical user interface 140, integrative functionalities such as the communications module 160 and document management module 180 are shown. In this embodiment, the communications module 160 has sub-modules 210, 220, 230 and 240 available as one-click options for a member 120. Each of these one click options are available to the member 120 as “buttons” on the graphical user interface 140.

FIG. 2 also shows sub-modules of the document management module 180 available as “buttons” on the graphical user interface 140. A member 120 may click on the “button” on the graphical user interface 140 for any sub-module. In FIG. 2, sub-modules 390, 400, and 420 are shown. Some sub-modules may have more than one “button.” For example, in FIG. 2, a member may click on a different part of the graphical user interface 140 for the sub-module 400 for word processing, the sub-module 400 for spreadsheets, and the sub-module 400 for presentations.

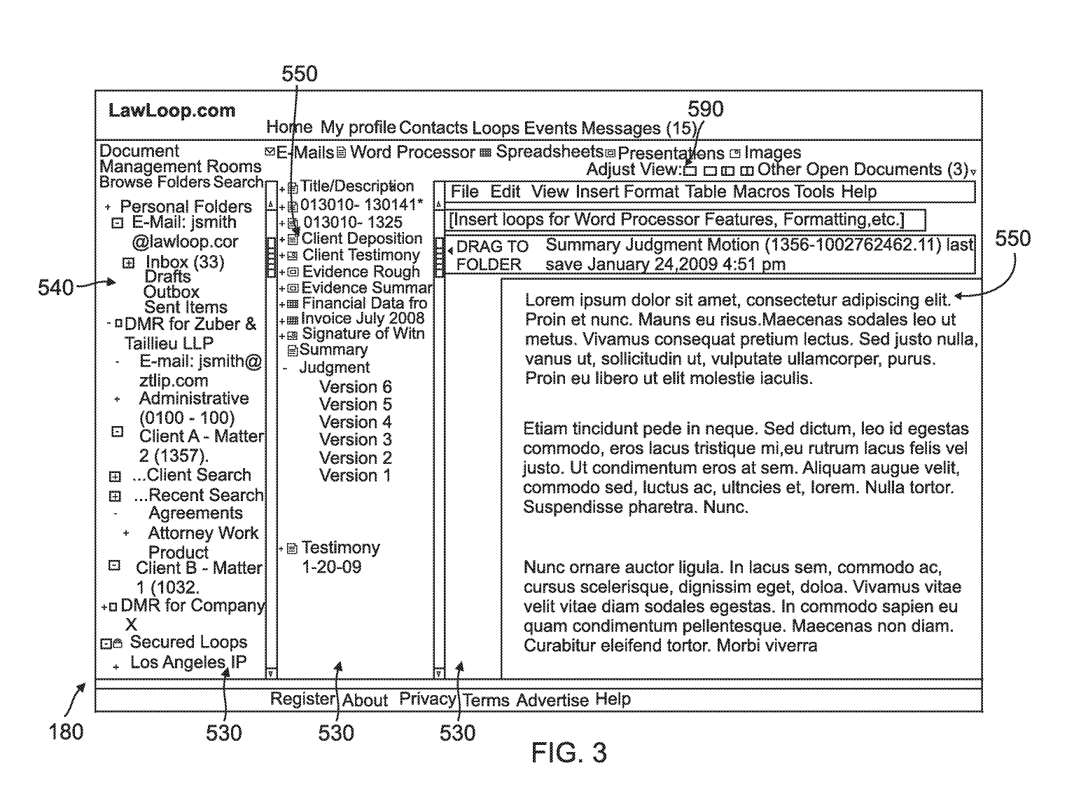

FIG. 3 shows an exemplary graphical implementation of another aspect of the present invention showing multiple windows 530 of a document management module 180. In FIG. 3, document management module 180 is divided into a folder window 530 showing multiple folders 540 as managed by the viewer sub-module 310, windows sub-module 360, and folders viewer sub-module 370. FIG. 3 also shows a document window 530 showing multiple documents 550 within a particular folder 540 as managed by the viewer sub-module 310, windows sub-module 360, and folders viewer sub-module 370. A viewer 590 in window 530 shows a document 550 selected from the list of documents 550.

The document management module 180 of the integrative functionalities 150 provides members 120 with several features for working with, editing, manipulating, and managing documents. Within the larger context of collaboration within a secure loop in the online community 110, members 120 and groups or networks of members 130 can come together with the present invention and work with documents using one or more of the integrative functionalities 150. Actions that a member 120 may take using the document management module 180 include clicking on an icon on a member virtual identity 640 existing in the context of the online community 110 and thereby giving the member 120 associated with such member virtual identity 640 access to (or retracting access of the member 120 associated with such member virtual identity 640 to) a document management room shared by a network that at least some members 120 associated with member virtual identities 640 do not have access to. Other actions include dragging a document stored in a first folder containing documents shared by members of a first network of members 130 (and not shared with members 120 not of said first network 130) to a second folder containing documents shared by members of a second network 130 (and not shared with members 120 not of said second network 130), such that the document is shared with members of the first network 130 and members of the second network 130, wherein at least one of said members of said second network 130 is not also a member 120 of said first network 130.

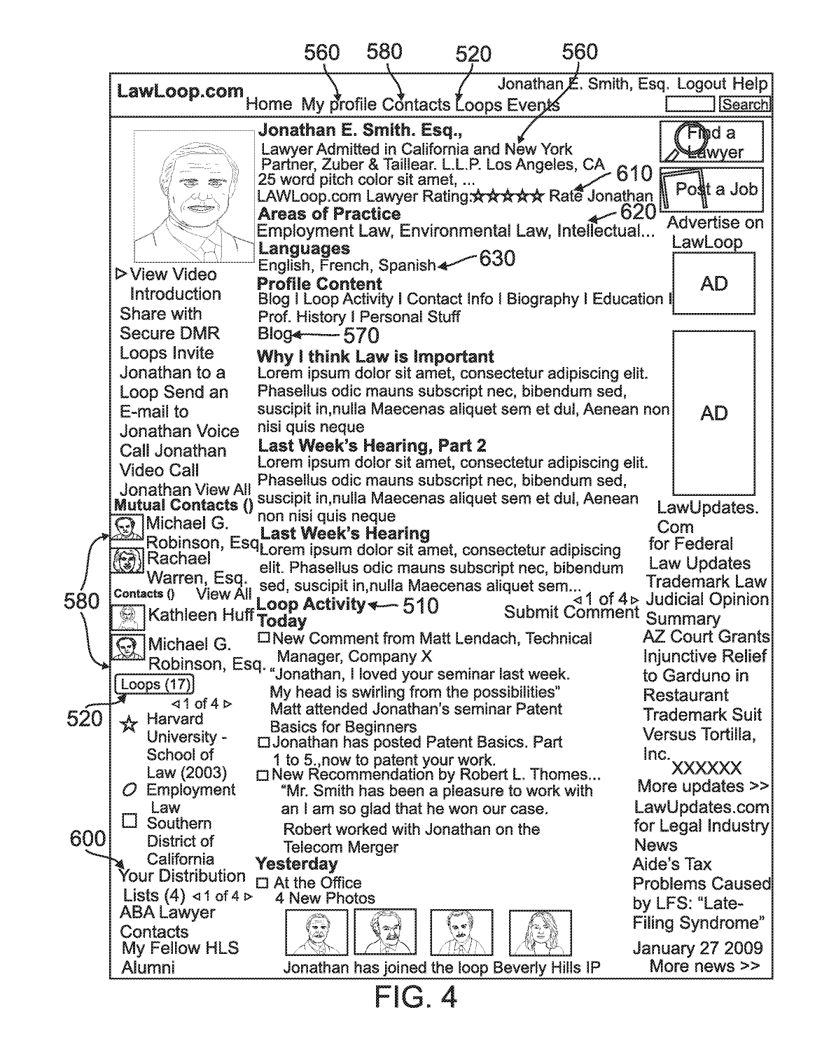

FIG. 4 is an exemplary graphical implementation of another aspect of the present invention showing a profile page 560 of a member 120. The profile page 560 of a member 120 shows various information about the member represented by the member's virtual identity 640, including areas of practice 620, languages 630, a lawyer rating 610, a blog section 570, and loop activity 510. The profile page 560 may also show a contact file management tool 580, loops 520, and distribution lists 600. Links may be provided to content such as the profile page 560 itself, the contact file management tool 580, loops 520, or any other content available to members 120 of the online community 110. Clicking on an icon representative of the member virtual identity 640 displays the information on the profile page 560. A member's 120 contacts 660 may be represented by an icon, and another member 120, regardless of network 130 membership, may simply import his or her contact information by clicking on the icon and dragging it to his or her contacts section of the member virtual identity 640.

### DETAILED DESCRIPTION OF ADDITIONAL EMBODIMENTS OF THE PRESENT INVENTION

The elements below may also be present in various embodiments of the present invention:

A method for interactively collaborating within a secure, server-based social networking community, comprising integrating a plurality of social networking functionality modules accessible to members of the community, the plurality of social networking functionality modules permitting the members to perform one or more tasks within the community; assembling the members into one or more networks of members, wherein at least one of the plurality of social networking functionality modules allows each member to participate in said one or more networks, and wherein the one or more networks are configured to exclude one or more members of the community; sharing one or more documents in a remote secure environment within the community, wherein excluded one or more members do not have access to the one or more documents; accessing software applications to remotely create, delete, edit and manage the one or more documents and view information about the one or more documents in a plurality of customizable and selectable viewing options; and communicating via a plurality of communications sub-modules each accessible via at least one interface in the community.

The method above, further comprising adding and deleting members from the one or more networks of members, wherein the adding or deleting is performed by a network administrator.

The method above, wherein the plurality of communications sub-modules at least include voice conferencing, video conferencing, emailing, messaging, instant messaging, calendaring, and a foreign language translation tool.

The method above, wherein the accessing software applications to remotely create, delete, edit and manage the one or more documents and view information about the one or more documents includes software applications selected from the group consisting of an email tool, word processor tool, a spreadsheet tool, a presentation tool, an image viewing tool, a document management tool, and a calendaring tool.

The method above, wherein the document management tool allows a member to manage a plurality of rooms of documents existing within the one more networks of members, such that at least one room of documents is shared within at least one of said network of members and is not shared with another one of said network of members.

The method above, wherein the member manages a room of documents such that at least one document in the one or more documents is shared within a network of members in the one or more network of members and at least one document in the one or more documents is not shared with the network of members in the one or more network of members.

The method above, wherein the document management tool allows a member to simultaneously view a plurality of windows, at least one of said plurality of windows having folders for storing the one or more documents, at least another one of the windows having the one or more documents stored in one of the folders, and at least a third one of the windows having the content of at least one of the documents.

The method above, wherein the document management tool incorporates an alternative image viewing tool allowing a member to alternate between a plurality of views of the one or more documents.

A method for transforming a social community having a plurality of members into a secure, server-based collaborative business environment, comprising linking a plurality of members together in a common network, the common network being a secure online location where the plurality of members can share information and where the plurality of members have a common professional or business interest; and integrating at least one social networking functionality module among a plurality of social networking functionality modules with the common network to facilitate secure communications among the plurality of members, wherein communications are initiated by a single click of an icon on a member virtual identity associated with at least one member of the plurality of members.

The method above, further comprising accessing software applications to remotely create, delete, edit and manage one or more documents and view information about the one or more documents.

The method above, wherein the accessing software applications includes software applications selected from the group consisting of an email tool, word processor tool, a spreadsheet tool, a presentation tool, an image viewing tool, a document management tool, and a calendaring tool.

The method above, wherein the document management tool allows a member to manage a plurality of rooms of documents existing within the common network, such that at least one room of documents is shared by members within the common network and is not shared with other members of the common network.

The method above, wherein the member manages a room of documents such that at least one document in the one or more documents is shared by members within common network and at least one document in the one or more documents is not shared by members within the common network.

A method for transforming a social community having a plurality of members into a secure, server-based collaborative business environment, comprising linking a plurality of members together in a common network, the common network being a secure online location where the plurality of members can share information and where the plurality of members have a common professional or business interest; and integrating at least one social networking functionality module among a plurality of social networking functionality modules with the common network to facilitate secure communications among members in the plurality of members who communicate in different languages, the communications between the members including translations from one language to at least one additional language, wherein translations are initiated by a single click of an icon on a member virtual identity associated with at least one member of the plurality of members.

The method above, wherein the at least one social networking functionality module among a plurality of social networking functionality modules is selected from a group consisting of voice conferencing, video conferencing, emailing, and messaging.

The method above, further comprising accessing software applications to remotely create, delete, edit and manage one or more documents and view information about the one or more documents.

The method above, wherein the accessing software applications includes software applications selected from the group consisting of an email tool, word processor tool, a spreadsheet tool, a presentation tool, an image viewing tool, a document management tool, and a calendaring tool.

The method above, wherein the document management tool allows a member to manage a plurality of rooms of documents existing within the common network, such that at least one room of documents is shared by members within the common network and is not shared with other members of the common network.

The method above, wherein the member manages a room of documents such that at least one document in the one or more documents is shared by members within common network and at least one document in the one or more documents is not shared by members within the common network.

A document management system, comprising a member management module configured to manage members of the online community and access to one or more documents in the document management system depending upon access permission of each member, wherein members are granted access permission based on membership in a profession and assignment to a project involving the one or more documents; a document viewing module configured to provide viewing options for the one or more documents, the document viewing module managing a plurality of windows and folders within which the one or more documents can be viewed, created, edited, and deleted; an upload and download module configured to manage an ability of members of the community to upload the one or more documents to the community and download from the community; a native platform module configured to allow members of the community to view and edit the one or more documents in their respective native formats and in their respective native applications; and a security module configured to allow access to the one or more documents in one or more secure rooms; wherein each of the modules are resident on and accessible from one or more remote processors, and accessible by members of the community via a graphical user interface to the community.

The system above, further comprising a software applications module configured to allow members to access various software applications, the software applications including an email tool, word processor tool, a spreadsheet tool, a presentation tool, an image viewing tool, a document management tool, and a calendaring tool.

The system above, wherein the viewing module allows a member to manage a plurality of rooms of documents existing within the community, such that at least one room of documents is shared by members within the common network and is not shared with other members of the common network.

The system above, wherein the member manages a room of documents such that at least one document in the one or more documents is shared by members within common network and at least one document in the one or more documents is not shared by members within the common network.

It is to be understood that other embodiments may be utilized and structural and functional changes me be made without departing from the scope of the present invention. The foregoing descriptions of the embodiments of the invention have been presented for the purposes of illustration and description. It is not intended to be exhaustive or to limit the invention to the precise forms disclosed. Accordingly, many modifications and variations are possible in light of the above teachings. For example, a member may communicate to the network administrator a request for an addition of a member to the at least one network of members by clicking on an icon on the network virtual identity of the at least one network. It is therefore intended that the scope of the invention not be limited by this detailed description.

1. A method for interactively collaborating within a secure, server-based social networking community, comprising:
a plurality of members, each of such members owning at least one member profile, which member profile is enabled with a plurality of social networking functionalities;
at least one network of member profiles that excludes at least one member of the social networking community, whereby members of said network share access to a set of documents in a secured remote environment, such that members not belonging to said network do not have access to said set of documents;
a document management tool for managing documents comprised of at least one software application chosen from a group consisting of a document filing application, a message application, an email application, a word processor application, a spreadsheet application, and a presentations application, whereby the document management tool enables said members of said network to remotely manage documents of said set of documents; and
an images application for viewing electronic documents;
wherein at least one electronic document is associated with at least one hard copy document by a code, and wherein the code is also associated with information about the location of the at least one hard copy document.

2. The method of claim 1, whereby a printed page bearing the code is associated with the at least one hard copy document.

3. The method of claim 1, whereby the at least one electronic document is searchable.

4. The method of claim 1, whereby the at least one electronic document is created by electronically scanning the at least one hard copy document.

5. The method of claim 1, whereby the at least one electronic document is created by scanning the at least one hard copy document, and whereby the at least one electronic document is automatically associated with text corresponding to the contents of the at least one hard copy document.

6. The method of claim 1, whereby a link to the member profile of the last member to check out a hard copy document is also associated with the corresponding code.

7. The method of claim 1, whereby a link to the member profile of the last member to check in a hard copy document is also associated with the corresponding bar code.

8. The method of claim 1, whereby the code is a function of a document number associated with the at least one electronic document by the document filing system.

9. The method of claim 1, whereby the code is a machine readable code.

10. The method of claim 1, whereby the code is a barcode.

11. A method for interactively collaborating within a secure, server-based social networking community, comprising:
a plurality of members;
at least one network of members that excludes at least one member of the social networking community, whereby members of said network share access to a set of documents in a secured remote environment, such that members not belonging to said network do not have access to said set of documents; and
a document management tool for managing documents comprised of an images application for viewing electronic documents;
wherein at least one electronic document is associated with at least one hard copy document by a code, and wherein the code is also associated with information about the location of the at least one hard copy document.

12. The method of claim 11, whereby a printed page bearing the code is associated with the at least one hard copy document.

13. The method of claim 11, whereby the at least one electronic document is searchable.

14. The method of claim 11, whereby the at least one electronic document is created by electronically scanning the at least one hard copy document.

15. The method of claim 11, whereby the at least one electronic document is created by scanning the at least one hard copy document, and whereby the at least one electronic document is automatically associated with text corresponding to the contents of the at least one hard copy document.

16. The method of claim 11, whereby the code is a function of a document number associated with the at least one electronic document by the document filing system.

17. The method of claim 11, whereby the code is a machine readable code.

18. The method of claim 11, whereby the code is a barcode.
